(19) United States
(12) Patent Application Publication
(10) Pub. No.: US 2018/0182000 A1
(43) Pub. Date: Jun. 28, 2018

(54) Systems and Methods for Use in Facilitating Donation Transactions to Payment Accounts

(71) Applicant: MASTERCARD INTERNATIONAL INCORPORATED, Purchase, NY (US)

(72) Inventors: Angela Ray Cook, Collinsville, IL (US); Jarrett Northington, Wentzville, MO (US); Steven Estes, O'Fallon, MO (US)

(21) Appl. No.: 15/387,954

(22) Filed: Dec. 22, 2016

(51) Int. Cl. G06Q 30/02; G06Q 20/40

(52) U.S. Cl. CPC G06Q 30/0279; G06Q 20/4014

(57) ABSTRACT

Systems and methods are provided for use in facilitating donation transactions to payment accounts. One exemplary method includes soliciting, by a computing device, a selection of a charity for a donation transaction, via an application programming interface (API), at a network-based interface affiliated with an issuer, in response to a donate input from a user authenticated to the network-based interface, and soliciting, by the computing device, a donation detail for the donation transaction, via the API, from the user. The method also includes, in response to the selection of the charity and the donation detail, identifying, by the computing device, in a user data structure, the payment account associated with the user and the issuer. And, the method further includes compiling an authorization request for the donation transaction based on the identified payment account and transmitting the authorization request to the issuer.

### FIELD

The present disclosure generally relates to systems and methods for use in facilitating donation transactions to payment accounts and, more particularly, to systems and methods for facilitating donation transactions to payment accounts, for example, through network-based interfaces associated with issuers of the payment accounts.

### BACKGROUND

This section provides background information related to the present disclosure which is not necessarily prior art.

People are known to donate to charities, which may include a variety of different formal or informal entities or persons. Donations may take the form of checks or cash mailed to the charities, or charges to and/or debits from payment accounts. Or, donations may take the form of time spent volunteering for the charities. When a payment account is the source of a donation, a user, generally, presents a credit card, for example, to the charity (or potentially credentials associated with the credit card), and the charity initiates a payment account transaction to the payment account in the amount of the donation. Upon authorization of the transaction, the credit line of the user is reduced by the amount of the donation, and then later the funds are cleared and settled between the user's payment account and an account associated with the charity.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in facilitating donation transactions to payment accounts;

FIG. 2 is a block diagram of a computing device that may be used in the exemplary system of FIG. 1;

FIG. 3 is an exemplary method, which may be implemented in connection with the system of FIG. 1, for facilitating a donation transaction to a payment account; and

FIGS. 4 and 5 are exemplary interfaces, which may be used in connection with the system of FIG. 1 and/or the method of FIG. 3 to facilitate a donation transaction to a payment account.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Donations may be funded by a variety of different sources, including payment accounts. The use of payment accounts to fund such donations often involves the user of the payment account presenting, at the least, credentials associated with the payment account to the charity, from which the charity then initiates a transaction for the donation. Uniquely, the systems and methods herein permit users to, alternatively, initiate donations to charities from their payment accounts, through network-based interfaces (e.g., websites, applications, etc.) associated with issuers of the payment accounts (as opposed to initiating the donations directly at or through the charities). In particular, for example, when a user accesses his/her payment account via such a network-based interface, he/she is initially authenticated to the payment account (and to the network-based interface). Then, once accessed (and authenticated), the user may elect to initiate a donation to a charity through the payment account. In turn, a donation engine (associated with a payment network, for example) exposes an application programming interface (API) to the user, called by the network-based interface, through which the user is able to select the charity (or multiple charities) and command the donation. In turn, the donation engine receives the donation command and identifies the payment account associated with the user, and then initiates a donation transaction (through the payment network) to an account associated with the selected charity. In this manner, the donation transaction may be initiated in an efficient and secure manner (e.g., behind the authentication necessary by the user to access the network-based interface and the user's payment account, etc.), without the user ever directly providing payment account credentials for his/her payment account to the charity.

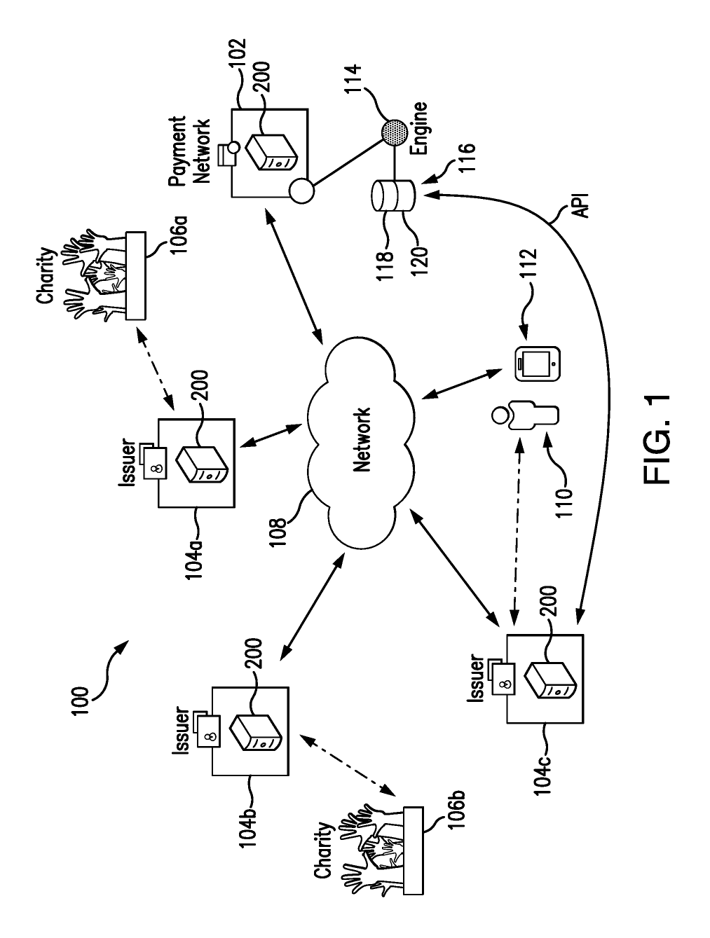

FIG. 1 illustrates an exemplary system 100 in which the one or more aspects of the present disclosure may be implemented. Although the system 100 is presented in one arrangement, other embodiments may include the parts of the system 100 (or other parts) arranged otherwise depending on, for example, affiliations of charities with different issuers, processing of donation transactions to charities, etc.

In this exemplary embodiment, the system 100 generally includes a payment network 102, three issuers 104a-c configured to issue accounts, and two charities 106a-b, each coupled to (and in communication with) network 108. The network 108 may include, without limitation, a local area network (LAN), a wide area network (WAN) (e.g., the Internet, etc.), a mobile network, a virtual network, and/or another suitable public and/or private network capable of supporting communication among two or more of the parts or users illustrated in FIG. 1, or any combination thereof. In addition, the network 108 may include multiple different networks such as, for example, a private payment network made accessible by the payment network 102 to the issuers 104a-c and, separately, a public network (e.g., the Internet, etc.) through which the issuers 104a-b and the charities 106a-b may communicate.

The charities 106a-b may each include any type of charity, which collects donation(s) (e.g., funds, etc.) to be used for the benefit of organizations, groups, persons, etc. For example, the charities 106a-b may include religious charities, social charities, demographic specific charities, event-based charities (e.g., flood relief, etc.), etc. In addition, the charities 106a-b are each associated with accounts, through which donations may be collected and processed. In this exemplary embodiment (for illustration only in the following discussion), the charity 106a is associated with an account issued by the issuer 104a (as indicated by the dotted line in FIG. 1), and the charity 106b is associated with an account issued by the issuer 104b (as also indicated by the dotted line in FIG. 1). The accounts may include any types of accounts, for example, savings accounts, checking accounts, payment accounts (e.g., prepaid accounts, debit accounts, credit accounts, etc.), etc.

In addition, as also shown in FIG. 1, the system 100 includes a user 110, which, in this embodiment, is a donor that desires to make one or more donations to one or both of the charities 106a-b, and/or to other charities. Similar to the above, the user 110 is associated with a payment account, which is issued to the user 110 by the issuer 104c (as indicated by the dotted line in FIG. 1). The user 110 may then use the payment account, for example, to purchase products (e.g., goods, services, etc.) from merchants (via purchase transactions at the merchants), as desired. In connection with the payment account, the issuer 104c hosts a website and/or provides an application (broadly, a network-based interface) through which the user 110 is able to authenticate himself/herself, via login credential(s) (e.g., a username, a password, a biometric, a personal identification number (PIN), etc.), and interact with the issuer 104c regarding the payment account (e.g., pay bills, view balances, change account controls or profiles, report lost/stolen cards, etc.). The user's payment account may then be a source of funds for the donations to be provided by the user 110, as described herein. In addition, the user 110 is also associated with a communication device 112. In the illustrated embodiment, the communication device 112 includes a portable communication device such as, and without limitation, a smartphone, a tablet, a laptop, etc. The communication device 112 is configured (e.g., via executable instructions, etc.) to operate as described in more detail below.

In various exemplary embodiments, users and charities involved in the different interactions herein (including the user 110 and the charities 106a-b) are prompted to agree to legal terms associated with their accounts, for example, during enrollment in their accounts with the various issuers associated therewith (including the issuers 104a-c), etc. In so doing, the users and charities may voluntarily agree, for example, to allow issuers of the payment accounts, payment networks, etc., to collect and use data during enrollment and/or collected in connection with processing/facilitating the various interactions and/or donation transactions herein, for one or more of the different purposes described herein.

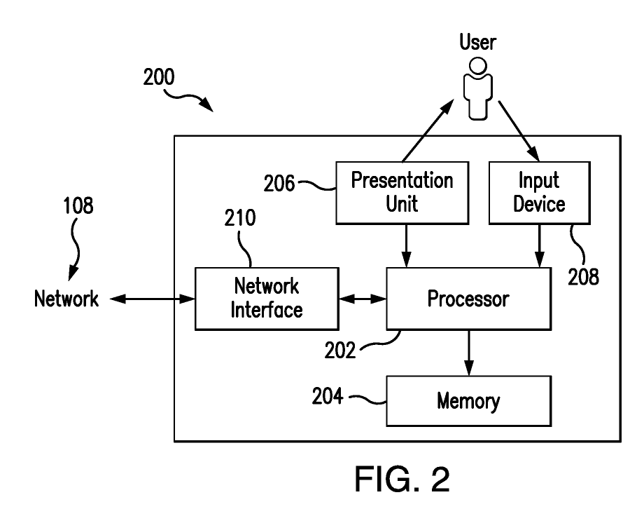

FIG. 2 illustrates an exemplary computing device 200 used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are configured to function as described herein. In the system 100, the payment network 102 and the issuers 104a-c are each illustrated as including and/or incorporating a computing device 200, coupled to (and in communication with) the network 108. In addition in the system 100, the charities 106a-b may each include at least one computing device consistent with computing device 200. Further, the communication device 112 associated with the user 110 may be considered a computing device consistent with computing device 200. With that said, however, the system 100 should not be considered to be limited to the computing device 200, as described below, as different computing devices and/or arrangements of computing devices may be used.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the operations described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, interbank card association (ICA) numbers, charity data structures (e.g., charity names, charity account identifiers, etc.), user data structures (e.g., user names, user primary account numbers (PANs), ICAs, etc.), various interfaces, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein.

In the exemplary embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information (e.g., charity selection interfaces, donation command interfaces, etc.), visually, for example, to a user of the computing device 200, such as, for example, user 110, etc. Various network-based interfaces (e.g., as defined by applications, websites, etc.) may be displayed at computing device 200, and in particular at presentation unit 206, to display and/or solicit certain information, as described herein. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

In addition, the computing device 200 includes an input device 208 that receives inputs from the user (i.e., user inputs) such as, for example, selections of charities (e.g., charities 106a-b, etc.), donation amounts, etc. The input device 208 is coupled to (and is in communication with) the processor 202 and may include, for example, one or more of a keyboard, a pointing device, a mouse, a stylus, a camera, a touch sensitive panel (e.g., a touch pad or a touch screen, etc.), and/or other suitable input device. Further, in various exemplary embodiments, a touch screen may behave as both a presentation unit 206 and an input device 208.

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 108. In some exemplary embodiments, the computing device 200 includes the processor 202 and one or more network interfaces (including the network interface 210) incorporated into or with the processor 202.

Referring again to FIG. 1, the system 100 further includes a donation engine 114, and a data structure 116 coupled to the donation engine 114. In this exemplary embodiment, the donation engine 114 forms part of the payment network 102 (e.g., is incorporated therein in association with computing device 200, etc.), as indicated by the interconnecting line between the payment network 102 and the donation engine 114. It should be appreciated, however, that the donation engine 114 may be separate from the payment network 102 (e.g., as a standalone computing device in the system 100, consistent with computing device 200; etc.), and/or may be incorporated otherwise in the system 100 or outside of the system 110 (e.g., in one or more other entities, etc.) in other embodiments. Likewise in the illustrated embodiment, the data structure 116 forms part of the payment network 102 (as associated with the donation engine 114), but may be separate therefrom or incorporated otherwise in the system 100 in other embodiments. In general, however, the data structure 116 is often incorporated, or not, consistent with the donation engine 114.

In the system 100, the data structure 116 generally includes two data structures: a user data structure 118 and a charity data structure 120. However, this is not required in all embodiments, as the data structure 116 may alternatively include a single data structure or more than two data structures.

In the illustrated embodiment, the user data structure 118 includes an entry for each of multiple users that have opted to make donations to charities through issuers of their accounts (and through the donation engine 114), including, for example, the user 110. Each entry may include, for example, a user identification (ID), a name of the user, a PAN for a payment account associated with the user, an ICA number for the issuer associated with the user's payment account, and an identification of the issuer (e.g., a name of the issuer, etc.). In addition, each entry may further include one or more of a routing number and an account number for the user's account (e.g., when the account involves a debit card, etc.), an identification of charities (and, potentially, their tax identifier (ID), etc.) to which the user has previously made donations, login credentials for the user, etc. With that said, Table 1 illustrates an exemplary entry in the user data structure 118, for the user 110.

TABLE 1

| | | | ICA | | |
|---|---|---|---|---|---|
| User ID | Name | PAN | Number | Issuer ID | . . . |
| User 110 | J. Smith | 1234-1234-1234-1234 | 123456 | Issuer 104c | . . . |

Similarly, the charity data structure 120 includes an entry for each of multiple charities, including, for example, the charities 106a-b. Each entry may include, for example, a charity identification (ID), a name of the charity, an account number for an account associated with the charity, an ICA number for the issuer associated with the charity's account, an identification of the issuer (e.g., a name of the issuer, etc.), and a tax identifier (ID) for the charity. In addition, each entry may further include a merchant identifier (ID) for the charity, etc. With that said, Table 2 illustrates exemplary entries in the charity data structure 120, for the charities 106a-b.

TABLE 2

| Charity | | | ICA | | | |
|---|---|---|---|---|---|---|
| ID | Name | Account | Number | Issuer | Tax ID | . . . |
| Charity | The Help Fund | 123-45678 | 654321 | Issuer | 12-987 | . . . |
| 106a | | | | 104a | | |
| Charity | Flood Relief | 098-7654321 | 13579 | Issuer | 12-478 | . . . |
| 106b | Assoc. | | | 104b | | |

It should be appreciated that the content of the entries in Tables 1 and 2, for the data structure 116, is exemplary only, and that other details, data or information about the user 110 (or other users) and/or charities 106a-b (or other charities) may be included in the data structure 116 in other embodiments.

It should also be appreciated that the entries in the data structures 118 and 120, of the data structure 116, are generally populated in response to registration of issuers (including the issuers 104a-c) and/or charities (including the charities 106a-b) to the donation engine 114 for participation in the operations herein. For example, in connection with registration of the issuer 104c, the issuer 104c may be subjected to an onboarding process in which the donation engine 114 requests certain information about the issuer 104c such as, without limitation, the issuer's ICA number, users associated with the issuer 104c to whom the features described herein will be offered (and their corresponding account information), etc. and stores such information in the user data structure 118.

Also, during registration of the issuer 104c, for example, a donation application (e.g., a widget, etc.) is provided to the issuer 104c (e.g., by the donation engine 114, etc.), which, in turn, is then integrated into the issuer's website and/or related banking application (broadly, the issuer's network-based interface(s)). As such, through the donation application at the issuer's website (and/or related application), a donation option is available to the user 110 when the user accesses his/her payment account (e.g., when the user 110 is logged-in to his/her payment account, etc.). And, upon selection of the donation option, the user's payment account may be used as a source of funds for a donation by the user 110. For example, when the user 110 accesses (e.g., logs-in to, etc.) his/her payment account at the issuer 104c (via the issuer's website and/or related banking application), the user 110 is authenticated by the issuer 104c. And, when the user 110 elects to make a donation to a particular charity through the issuer 104c (as described herein), the user 110 can select the donation application, which allows identification of the available registered charities to the user 110 and collects data for the user 110 and forwards it to the engine 114/data structure 116 for storage in user data structure 118 for use as described herein.

In particular in this exemplary embodiment, the payment network 102 (e.g., via the donation engine 114, etc.) is configured to expose an API (e.g., a donation engine API, etc.) to the donation application (as integrated into the website and/or related application associated with the issuer 104c) in connection with facilitating a donation by the user 110 through the payment account issued to the user 110 by the issuer 104c. As such, upon selection of the donation option/application by the user 110 to make a donation via his/her payment account (when the user 110 accesses his/her payment account via the issuer's website and/or banking application), the donation application calls the API. In turn, the donation application is configured to cause one or more donation interfaces to be display to the user 110. The interfaces initially solicit selection of a charity from the user 110, based on available registered charities in the charity data structure 120 (e.g., based on a listing of available charities from which the user 110 can select, etc.) (e.g., one of the charities 106a-b, etc.), and entry and/or selection of donation details (e.g., amount, frequency, etc.) for the donation. In addition, the interfaces may solicit, from either the user 110 or the issuer 104c, details relating to the user's payment account such as a name of the user 110 making the donation, the ICA number of the issuer 104c, etc. The donation engine 114 is configured, via the API, to then receive the various information (e.g., the selection of the charity, the donation details, etc.), via the interfaces, as a donation command by the user 110. Generally, the donation command will not include the PAN for the user's payment account, thereby potentially omitting certain personal identifying information (PII) for the user 110 from the transaction. However, the user may still be solicited to provide various other details associated with the payment account (e.g., an expiration date for a payment card associated with the payment account, for example, where the payment card includes a prepaid card or a credit card; etc.).

Then, once received, the donation engine 114 is configured to access the user data structure 118 and identify the payment account for the user 110 (e.g., the PAN, etc.), based on the donation command, and in particular, based on the name of the user 110 and the ICA number of the issuer 104c as included in the donation command. In turn, the donation engine 114 is configured to initiate a payment account transaction for the donation (more specifically, an authorization request for the donation transaction), through the payment network 102. The transaction is generally directed to the issuer 104c associated with the user's payment account and the issuer associated with the charity selected by the user 110 (as identified in the donation command). In response, when the issuer 104c authorizes the transaction, it is recorded at the issuer 104c and at the issuer associated with the selected charity. The transaction is later cleared and/or settled by and between the issuer 104c and the issuer associated with the selected charity (via appropriate agreement), and by and between the selected charity and its associated issuer (by appropriate agreement).

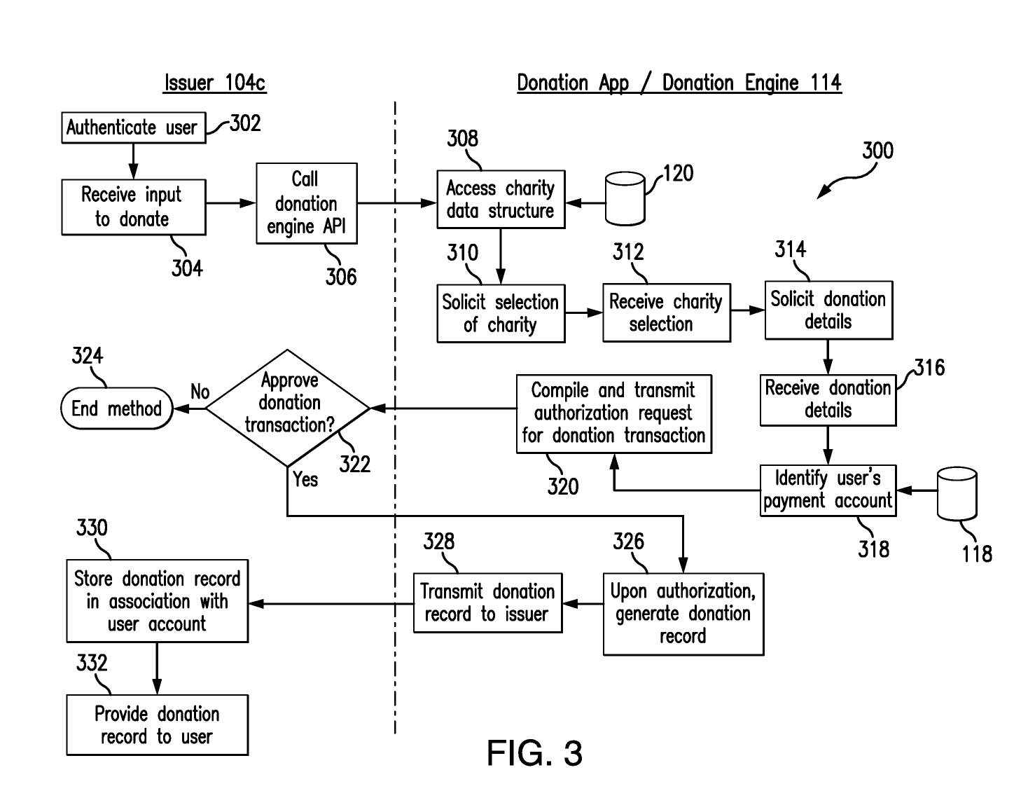

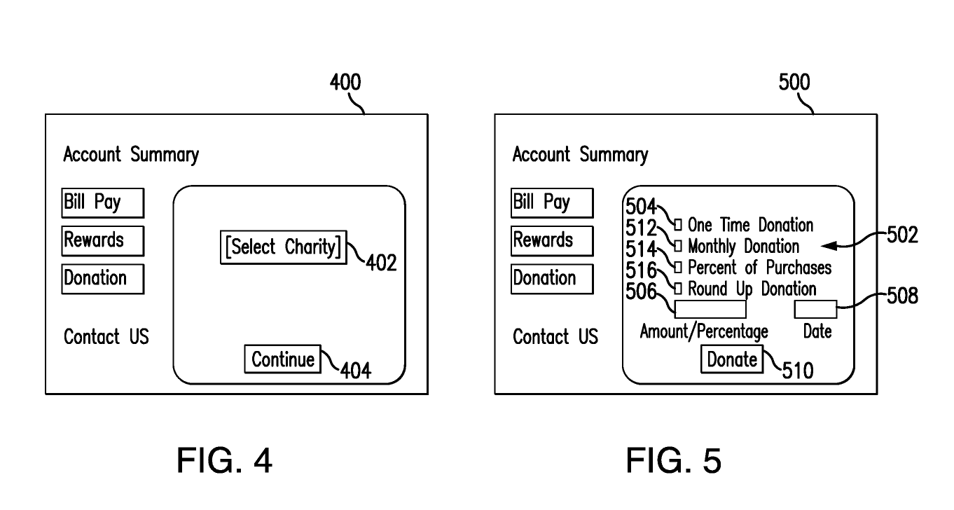

FIG. 3 illustrates an exemplary method 300 for facilitating a donation transaction to a payment account. The method 300 is generally described as implemented in the donation engine 114 in the system 100 and in the issuer 104c, and further with reference to the computing device 200. It should be appreciated, however, that the methods herein are not limited to the system 100 and/or the computing device 200. Likewise, the systems and computing devices herein are not limited to method 300. In addition, the method 300 is also described with reference to two exemplary interfaces 400 and 500 shown in FIGS. 4-5. The exemplary interfaces 400 and 500, however, are merely for purposes of illustration and should not be understood to limit the systems and methods described herein.

Referring to FIG. 3, at the outset in the method 300, the user 110 initially accesses, at the communication device 112, a web site (broadly, a network-based application) associated with the issuer 104c, through which the user 110 can interact with the issuer 104c as desired (e.g., regarding his/her payment account, etc.). In response, and in order for the user 110 to access his/her payment account (e.g., in order for the user 110 to log-in to his/her payment account, etc.), the user 110 is invited to authenticate himself/herself by providing one or more credentials such as, for example, a user name, a password, a PIN, a biometric, a security word, etc. When the proper credential(s) are provided, the issuer 104c (and specifically, the issuer's website) authenticates the user 110, at 302. After such authentication, the user 110 is then permitted access to his/her payment account, and to utilize the website as it pertains to the user's payment account (e.g., view account balance details, access bill pay services, access rewards, effect changes to the user's account profile, etc.). While the above is described in connection with the issuer's website, it should be appreciated that the user 110 may instead access a banking application (or other network-based application and/or interface) provided by the issuer 104c, at the communication device 112, to similarly interact with the issuer 104c and access the user's payment account.

In the method 300, and as described above in connection with the system 100, the website associated with the issuer 104c includes a donation application (or widget), which presents the user 110 with the option (e.g., via a selectable link, etc.) to donate to a charity (e.g., to one of the charities 106a-b, etc.) after the user 110 is authenticated to his/her payment account (e.g., after the user 110 logs-in to his/her payment account, etc.). As such, when the user 110 desires to make a donation, the user 110 can select the option to donate (e.g., while logged-in to his/her payment account, etc.). In turn, the issuer 104c receives an input to make a donation from the user′ payment account, at 304. And, in response to the input, the issuer 104c (and in particular, the issuer's website) launches the donation application, which then calls the donation engine API, at 306.

When the donation engine API is called, the donation engine 114 accesses the charity data structure 120 (of the data structure 116), at 308, to determine what charities are eligible to be presented to the user 110 for the donation (e.g., the charities 106a-b as shown in Table 2, etc.). In so doing, the donation engine 114 may present all available charities to the user 110 (e.g., all charities registered to the donation engine 114, etc.), from which the user 110 can select one or more of the charities. Or, the donation engine 114 may filter the listing of charities presented to the user 110, for example, based on location of the charity and/or the user 110, based on preferences provided by the user 110, etc. Regardless, the donation engine 114 then responds to the user 110, via the donation engine API, and solicits, at 310, a selection of one of the identified charities (the charity 106a in the following discussion). In turn, the donation engine 114 receives the charity selection, at 312, via the donation engine API (as part of a donation command from the user 110).

In particular in this example, in connection with soliciting a charity selection from the user 110 at 310, the donation engine 114 causes the exemplary interface 400, shown in FIG. 4, to be displayed to the user 110 at the communication device 112 (specifically, at the presentation unit 206). As shown, the interface 400 includes a drop down menu 402. The drop down menu 402 is populated with a listing of the charities identified from the charity data structure 118 (at 308) and available for selection by the user 110 for receiving the donation (e.g., the charities 106a-b). As such, in response to the solicitation by the donation engine 114 (at 310), the user 110 can select the drop down menu 402, and one of the listed charities therein (e.g., charity 106a, etc.). The user 110 then selects a “Continue” button 404, to submit the charity selection to the donation application and/or the donation engine 114 (as part of the donation command).

Referring again to FIG. 3, the donation engine 114 next solicits, at 314, one or more donation details from the user 110 for the desired donation to the selected charity. Such donation details may include, for example, an amount of the donation, a time frame for the donation, and indication of whether the donation is a one-time donation or a recurring donation (broadly, a frequency of the donation), etc. In turn, the donation engine 114 receives the donation details from the user 110, at 316, via the donation engine API (again as part of the donation command from the user 110).

In particular in this example, in connection with soliciting the donation details from the user 110 for the desired donation to the charity 106a, the donation engine 114 causes the exemplary interface 500, shown in FIG. 5, to be displayed to the user 110 at the communication device 112 (specifically, at the presentation unit 206). As shown, the exemplary interface 500 includes four different options 502 for the donation type: a one-time donation, a monthly donation, a percent of purchase donation, and a round up donation. For a one time donation, for example, the user 110 selects the checkbox 504, and further enters, into field 506, the amount of the one-time donation. The user 110 may further enter a particular date on which the donation is to be made into the date field 508, or not, and then select a “Donate” button 510 to submit the donation (as part of the donation command).

Similarly in the interface 500, for a recurring monthly donation, the user selects the checkbox 512 and enters a desired amount for the monthly donation in the field 506. Here, the user may be required to enter a date into the date field 508, or not, to specify the day of each month on which the recurring donation will be performed. For the percentage of purchase donation, the user 110 selects the checkbox 514 and then enters a desired donation percentage into the field 506. For example, if the user 110 enters 1%, the donation will include a donation from the user's payment account of 1% of all transactions involving the user's payment account, immediately or at some regular (or irregular) interval (e.g., as specified in the date field 508, when selected in combination with the monthly donation option, etc.). And, for the round up donation, the user 110 selects the checkbox 516, which results in all transactions to the user's payment account being rounded up to the nearest dollar (or other demonization) with the excess funds then being donated to the selected charity 106a, again immediately or at some regular (or irregular) interval.

While multiple exemplary types of donations are provided in the interface 500, it should be appreciated that still other types of donations (or different combinations of donations) may be included in interfaces in other method embodiments. In some embodiments, the types of donations included in the interfaces may depend on the types of accounts associated with the particular consumers (e.g., round-up donations may be available for credit accounts and pre-paid accounts but not for debit accounts, etc.). Further, the types of donations provided may be modified or expanded to offer more or less flexibility to the user 110 and other users in making donations. For example, in connection with donations linked to transactions by the user 110 via the payment account (e.g., a percent of purchase donation, a round up donation, etc.), a donation interface may further allow the user 110 to limit the donation(s) to particular transactions by merchant, by merchant type (e.g., as indicated by a merchant category code (MCC), etc.), by time of day, by day of the week, by month of the year, etc.

Further, it should be appreciated that while the exemplary interfaces 400 and 500 generally segregate the selection of the charity and the entry of the donation detail(s), in other embodiments such information may be solicited through a single interface (such that operations 312 and 316 occur at substantially the same time, in connection with receiving the donation command from the user 110), or through a different number of interfaces (e.g., more than two interfaces, etc.), based on, for example, a desired and/or efficient manner of soliciting such information from the user 110 and/or handling information through the donation engine API, etc.

With reference again to FIG. 3, in connection with receiving the donation command from the user 110, the donation engine 114 also receives (as part of the donation command) information relating to the user 110 from the issuer 104c, via the API. For example, the donation engine 114 may receive the name of the user 110 (e.g., J. Smith, etc.), the ICA number associated with the issuer 104c of the user's payment account (e.g., 123456, etc.), and still other data as desired or required. Alternatively, the donation engine 114 may receive much of this information in advance (and store the received information in the user data structure 118) in connection with registering the issuer 104c, as described above.

Next, in response to receiving the donation command (and the various components thereof), the donation engine 114 identifies, at 318, the user's payment account. In particular, the donation engine 114 accesses the user data structure 118 (of the data structure 116) and searches for the user's name and the ICA number associated with the issuer 104c, as included in the donation command. With reference to the user information included in Table 1, for example, the donation engine 114 may search for the combination of J. Smith and the ICA 123456. In turn, based on this search, a match is identified in the user data structure 118, and the donation engine 114 is able to identify the user's payment account, by the PAN 1234-1234-1234-1234. With that said, while only the user name and the ICA are utilized to identify the payment account in the above example, it should be appreciated that any other data included in the donation command may be also (or alternatively) used to identify the user's payment account in the user data structure 118. For example, restrictions may be imposed or desired, which limit the PII included in the donation command such that other data may be included and, thus, used to identify the user's payment account. In general, though, the PAN for the user's payment account will not be included in the donation command. And, in connection therewith, the payment application at the issuer 104c, in connection with facilitating the donation command, will be payment card industry (PCI) compliant.

Once the user's payment account is identified, the donation engine 114 compiles and transmits a donation transaction request, at 320. The request is directed to the issuer 104c, as an authorization request for the donation transaction. In general, the donation engine 114 compiles the authorization request for the donation transaction consistent with the donation details included in the donation command. For example, when a one-time donation is commanded by the user 110, the donation engine 114 may immediately compile and transmit the authorization request (unless a particular, later date is indicated for the donation). Conversely, when the donation is based on a transaction (e.g., a percent of purchase donation, a round up donation, etc.), the donation engine 114 may wait until a qualifying transaction to the payment account is identified and then, at that time, or at some later time, compile and transmit the authorization request for the donation transaction. Further, when the donation command defines multiple donations (e.g., based on a round up donation for all transactions to the user's payment account, etc.), the donation engine 114 may hold the individual donations for an interval prior to compiling and transmitting the authorization request for the donation transaction (with the authorization request then including the sum of the held donations), or alternatively, the donation engine 114 may compile and transmit request for each donation for each individual transaction (as the donation command is satisfied).

Regardless, however, of when the authorization request for the donation transaction is made, the issuer 104c, upon receipt, determines, at 322, whether to approve or decline the donation transaction (e.g., determines whether the user's account is in good standing and whether there is sufficient credit or funds to cover the donation transaction, etc.). In so doing, if the donation transaction is approved, the issuer 104c returns an authorization reply to the payment network 102 (and the donation engine 114), approving the transaction. In turn, the payment network 102 (and the donation engine 114) provides the authorization reply to the issuer 104a associated with the selected charity 106a (in this example). The donation transaction is later cleared and settled between the payment network 102 and the issuers 104a and 104c. However, if the donation transaction is declined, the issuer 104c returns an authorization reply to the payment network 102 (and the donation engine 114) declining the transaction, thereby causing the method 300 to end, at 324.

Upon approval/authorization of the donation transaction by the issuer 104c, the donation engine 114 generates a donation record for the donation transaction, at 326. The donation record may include, for example, the name of the charity 106a, the date of the donation transaction, the amount of the donation transaction, and the Tax ID of the charity 106a, and any further information to evidence the donation to the charity 106a by the user 110. The donation engine 114 then transmits the donation record to the issuer 104c, at 328.

Then, upon receipt of the donation record, the issuer 104c stores the donation record in association with the user's payment account, at 330. At that time, or subsequently, the issuer 104c provides the donation record to the user 110, at 332. The donation record may be provided to the user 110 upon receipt by the issuer 104c, or at a particular time of the month or year (e.g., in a tax preparation period, etc.), or upon request form the user 110. For example, the user 110 may log-in to his/her payment account via the issuer's website and access the donation record (and any other donation records for the user 110), which may then be emailed or printed at the user's direction.

While the method 300 is generally described with reference to selection of the charity 106a, it should be appreciated that the method 300 equally applies to selection of the charity 106b by the user 110. In addition, it should also be appreciated that the user 110 is able to make multiple donation transactions to multiple different charities, as desired, through the donation engine 114.

Further, the above description references the donation engine 114 as performing various operations in connection with a donation transaction. It should be appreciated, however, that several of the operations (e.g., soliciting selection of a charity, soliciting donation details, etc.) may be performed by the donation engine 114 or by the donation application included in the issuer's website (or associated banking application, etc.), or by cooperation of the donation engine 114 and/or the donation application.

Moreover, in addition to the issuer 104c, for example, providing the ability to donate through the website (or application), and registering different charities thereto, the issuer 104c may further incentivize the user 110 to make donations through the issuer 104c in this exemplary embodiment. For example, the issuer 104c may provide 0.25 percent cash back on donation transactions, or assign increased rewards for donation transactions and/or distribute offers, discounts, and/or rebates to users (including the user 110) for making donation transactions, or provide particular benefits to the user 110. What's more, the issuer 104c may further identify or highlight particular charities at particular times and then offer such incentives (or offer enhanced incentives) to the user 110 to make donations through the issuer 104c to the identified particular charities.

In view of the above, the systems and methods herein enable donations to be coordinated by payment networks (via donation engines) through use of issuers' websites and/or applications, thereby relying on authentication of users provided by the websites and/or applications to similarly authenticate the users in connection with donation transactions. The donation transactions are further coordinated with limited amounts of information being transferred from the users making the donations (and/or the corresponding issuers) to the donation engines, thereby providing data security compliance and/or reducing the exposure of personal identifying information for the users. What's more, even with such added efficiencies and enhanced security, as applicable, the systems and methods herein provide for an efficient and convenient manner of providing donations, which are funded by accounts issued by the issuers to the users, to the charities through generally direct interaction with the issuers (e.g., with their websites, applications, etc.).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transforms a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by one or more of: (a) soliciting a selection of a charity for a donation transaction, via an application programming interface (API), at a network-based interface affiliated with an issuer, in response to a donate input from a user authenticated to the network-based interface; (b) soliciting at least one donation detail for the donation transaction, via the API, from the user; (c) in response to the selection of the charity and the at least one donation detail, identifying in a user data structure, the payment account associated with the user and the issuer; (d) compiling an authorization request for the donation transaction based on the identified payment account and transmitting the authorization request to the issuer, thereby permitting a donation to the charity to be initiated through the network-based interface affiliated with the issuer; (e) causing multiple charities to be displayed to the user, via the API; and (f) receiving a name of the user and an interbank card association (ICA) number associated with the issuer and searching in the user data structure for the name of the user and the ICA number.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

In addition, as used herein, the term product may include a good and/or a service.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer implemented method for use in facilitating donations to one or more charities, the method comprising:
soliciting, by at least one computing device, a selection of a charity for a donation transaction, via an application programming interface (API), at a network-based interface affiliated with an issuer, in response to a donate input from a user authenticated to the network-based interface;
soliciting, by the at least one computing device, at least one donation detail for the donation transaction, via the API, from the user;
in response to the selection of the charity and the at least one donation detail, identifying, by the at least one computing device, in a user data structure, a payment account associated with the user and the issuer; and
compiling an authorization request for the donation transaction based on the identified payment account and transmitting the authorization request to the issuer, thereby permitting a donation to the charity to be initiated through the network-based interface affiliated with the issuer.

2. The computer-implement method of claim 1, further comprising causing multiple charities to be displayed to the user, via the API; and
wherein the selection of the charity includes a selection of one of the multiple charities.

3. The computer-implemented method of claim 1, further comprising receiving, at the at least one computing device, a name of the user and an interbank card association (ICA) number associated with the issuer and searching in the user data structure for the name of the user and the ICA number; and
wherein identifying the payment account associated with the user and the issuer includes identifying, in the user data structure, the payment account associated with the name of the user and associated with the ICA number associated with the issuer.

4. The computer-implemented method of claim 3, further comprising generating, by the at least one computing device, a donation record for the donation transaction and transmitting the donation record to the issuer.

5. The computer-implemented method of claim 4, further comprising receiving, by the at least one computing device, an authorization reply from the issuer approving the donation transaction;
wherein generating the donation record for the donation transaction includes generating the donation record for the donation transaction after receiving the authorization reply from the issuer approving the donation transaction.

6. The computer-implemented method of claim 1, wherein the at least one donation detail includes an amount of the donation transaction; and
wherein the authorization request for the donation transaction includes the amount.

7. The computer-implemented method of claim 6, wherein the amount is based on an amount of a transaction to the payment account; and
wherein compiling the authorization request for the donation transaction includes compiling the authorization request for the donation transaction in response to the transaction to the payment account.

8. The computer-implemented method of claim 1, further comprising:
receiving, at the at least one computing device, the selection of the charity from a menu of multiple charities; and
receiving, at the at least one computing device, a name of the user and an interbank card association (ICA) number of the issuer from the issuer, via the API.

9. A system for use in facilitating donation transactions to payment accounts, the system comprising:
a memory including a first and a second data structure, the first data structure including user names, interbank card association (ICA) numbers for issuers of multiple payment accounts, and primary account numbers (PANs) for the multiple payment accounts, and the second data structure including indicators of multiple charities and tax IDs associated with each of the multiple charities; and
a donation engine coupled to the memory and configured to:
receive, via an application programming interface (API), a name of a user authenticated to a network-based interface affiliated with an issuer and an ICA number for the issuer;
receive, via the API, a selection of at least one of the multiple charities included in the memory, and at least one donation detail for a donation transaction to the at least one of the multiple charities;
identify, in the first data structure, a PAN for a payment account associated with the user, based on at least the name of the user and the ICA number for the issuer;
transmit an authorization request for the donation transaction, to the issuer, consistent with the selection of the at least one of the multiple charities and the at least one donation detail;
generate a donation record, including the tax ID for the selected at least one of the multiple charities as retrieved from the second data structure, after the authorization request for the donation transaction is approved; and
transmit the donation record to the issuer.

10. The system of claim 9, wherein the donation engine is further configured to receive an authorization reply from the issuer approving the donation transaction; and
wherein the donation engine is configured, in connection with generating the donation record after the authorization request for the donation transaction is approved, to generate the donation record in response to receiving the authorization reply from the issuer approving the donation transaction.

11. The system of claim 9, wherein the donation engine is configured to generate and transmit the donation record only after the donation transaction is cleared and settled.

12. The system of claim 9, wherein the donation engine is further configured to cause a listing of the multiple charities included in the memory to be displayed to the user, via the API, so that the user can select the at least one of the multiple charities from the listing.

13. The system of claim 12, wherein the donation engine is configured, in connection with receiving the name of the user and the ICA number for the issuer, to receive the name of the user and the ICA number for the issuer from the issuer, via the API.

14. The system of claim 13, wherein the donation engine is configured to compile the authorization request for the donation transaction, the authorization request including the at least one donation detail;
wherein the at least one donation detail includes a donation amount based on an amount of a purchase transaction to the payment account; and
wherein the donation engine is configured, in connection with transmitting the authorization request for the donation transaction, to transmit the authorization request for the donation transaction in response to the purchase transaction to the payment account.

15. A non-transitory computer-readable storage media including executable instructions for use in facilitating donations to one or more charities, which when executed by a processor, cause the processor to:
receive, via an application programming interface (API), a name of a user authenticated to a network-based interface affiliated with an issuer and an interbank card association (ICA) number for the issuer, in response to a donate input from the user to the network-based interface;
solicit, via the API, at the network-based interface, a selection of a charity from the user for a donation transaction;
solicit, via the API, at the network-based interface, at least one donation detail from the user for the donation transaction;
identify, in a data structure, a primary account number (PAN) for a payment account associated with the user, based on at least the name of the user and the ICA number for the issuer;
transmit an authorization request for the donation transaction, to the issuer, consistent with the selection of the charity and the at least one donation detail;
generate a donation record for the donation transaction and transmit the donation record to the issuer, the donation record including a tax ID for the selected charity as retrieved from the data structure.

16. The non-transitory computer-readable storage media of claim 15, wherein the executable instructions, when executed by the processor, cause the processor, in connection with soliciting the selection of the charity from the user, to:
cause a donation interface to be displayed to the user comprising a listing of multiple available charities from which the user can select to make a donation; and
receive the selection of the charity from the user, from the listing of multiple charities, via the donation interface.

17. The non-transitory computer-readable storage media of claim 16, wherein the executable instructions, when executed by the processor, cause the processor, in connection with soliciting the at least one donation detail from the user for the donation transaction, to:
cause another donation interface to be displayed to the user to allow the user to indicate the at least one donation detail; and
receive the at least one donation detail from the user via the another donation interface.

18. The non-transitory computer-readable storage media of claim 15, wherein the executable instructions, when executed by the processor, cause the processor, in connection with transmitting the authorization request for the donation transaction to the issuer, to compile the authorization request for the donation transaction and transmit the compiled authorization request to the issuer; and
wherein the executable instructions, when executed by the processor, further cause the processor to receive an authorization reply from the issuer, in response to the authorization request, approving the donation transaction.

19. The non-transitory computer-readable storage media of claim 18, wherein the executable instructions, when executed by the processor, cause the processor, in connection with generating the donation record for the donation transaction, to generate the donation record for the donation transaction in response to the authorization reply from the issuer approving the donation transaction.

20. The non-transitory computer-readable storage media of claim 18, wherein the executable instructions, when executed by the processor, cause the processor, in connection with generating the donation record for the donation transaction, to generate the donation record for the donation transaction only after the donation transaction is cleared and settled.
